(19) United States
(12) Patent Application Publication
(10) Pub. No.: US 2002/0015270 A1
(43) Pub. Date: Feb. 7, 2002

(54) Device for smoothing current and voltage transients and for preventing electric arcs forming while connecting and disconnecting a power supply battery and electrical equipment

(75) Inventor: Laurent Bonnet, Pegomas (FR)

Correspondence Address: SUGHRUE, MION, ZINN, MACPEAK & SEAS, PLLC, Suite 800, 2100 Pennsylvania Avenue, N.W., Washington, DC, 20037-3213, US

(73) Assignee: ALCATEL

(21) Appl. No.: 09/911,695

(22) Filed: Jul. 25, 2001

(30) Foreign Application Priority Data
Jul. 27, 2000 (FR) 00 09 837

(51) Int. Cl. H01H 9/30

(52) U.S. Cl. 361/10

(57) ABSTRACT

A device for smoothing current and voltage transients and for preventing an electric arc being formed during a connection operation whereby a power supply battery is put into circuit with high-power electrical equipment that it is to power, and/or during the opposite, disconnection operation during which the circuit via which the battery powers the equipment is interrupted. It provides for inserting a circuit for smoothing current/voltage transients to compensate for any voltage unbalance that might appear between the two terminals between which the connection between the battery and the equipment is alternately made and broken, one of the terminals belonging to the battery and the other to the equipment.

The invention relates to a device for preventing an electric arc forming during a connection operation in which a power supply battery is put into circuit with high-power electrical equipment that it is to power, when said circuit is likely to draw electrical current as soon as it is connected, and/or during the opposite disconnection operation, during which the circuit via which the battery powers the equipment is interrupted.

### BACKGROUND OF THE INVENTION

As is known, when a low impedance energy source such as an electrically charged power supply battery is put into circuit with a capacitive circuit constituting a low impedance load, current is initially generated that is limited only by the low impedances present in the circuit, and as a result the magnitude of the current can be very high. Electric arcing occurs between the connection members via which the battery and the equipment are put into connection when they are put into circuit with each other. This can happen, for example, when a connection piece connected to the positive terminal of the battery comes into contact with a connection piece connected to one of the power supply terminals of the equipment. This assumes that the battery and the equipment are also already interconnected over another link, e.g. a ground link, connecting the negative terminal of the battery to a second power supply terminal of the equipment.

As is also known, an electric arc can occur between the connection members via which a power supply battery and equipment constituting an inductive load are connected together, when said electric circuit is interrupted. This interruption can occur, for example, during a disconnection operation when two connection pieces are separated from each other, one of the pieces being connected to the battery and the other to the equipment, which pieces were previously electrically in contact.

The appearance of an electric arc during a stage of connecting or disconnecting a battery and equipment constitutes a phenomenon that is harmful, and must under some circumstances be totally avoided. This applies in particular when connection and/or disconnection can happen in a medium that contains matter that is easily ignited or explosive, or when it is necessary to eliminate all risk of the battery, the equipment, and the hardware being damaged in any way.

One known solution, that is used for equipment that is to be put into orbit, consists in connecting a battery to the equipment which it is to power while the battery is completely discharged and its connection terminals are temporarily short-circuited. Thereafter, the battery is charged electrically without the equipment being disconnected, which in practice leads to the equipment then being in operation. It is then difficult to monitor accurately the capacity of the battery when fully charged, which leads to overdimensioning the batteries of such equipment. Such a solution is not very satisfactory, particularly for applications in which efforts are made to optimize the charge of the battery to be connected.

### OBJECTS AND SUMMARY OF THE INVENTION

The invention thus provides a device for smoothing current and voltage transients and for preventing an electric arc being formed during a connection operation whereby a power supply battery is put into circuit with high-power electrical equipment that it is to power, and/or during the opposite, disconnection operation during which the circuit via which the battery powers the equipment is interrupted.

According to a characteristic of the invention, the device provides for inserting a circuit for smoothing current/voltage transients to compensate for any voltage unbalance that might appear between the two terminals between which the connection between the battery and the equipment is alternately made and broken, one of the terminals belonging to the battery and the other to the equipment.

According to the invention, the transient-smoothing circuit comprises:

an attenuator unit comprising at least one transistor for interposing between the positive terminal of the battery and the corresponding terminal of the equipment between which the connection between the battery and the equipment is alternately made and broken, the connection being obtained by successively interconnecting: a first terminal of the battery with a corresponding power supply terminal of the equipment; a first terminal of the attenuator unit and of the smoothing circuit with a second terminal which is either the second power supply terminal of the equipment or the second terminal of the battery; and then a second terminal of the attenuator unit and of the smoothing circuit with the battery terminal or the equipment terminal that remains to be connected; and

a control unit for controlling the grid of the transistor(s), said unit comprising a resistor-capacitor (RC) circuit including at least one capacitive element and at least one resistive element, the capacitive element being interposed between the control grid and the “output” electrode of at least one of said transistor(s), which is connected to the terminal of the device for connection to the positive terminal of the equipment, the resistive element being inserted between the control grid and a switch member which enables it to be connected in alternation either to the terminal of the device to which the output electrode(s) is/are connected, the resistive element then being connected in parallel with the capacitive element, or else to the same terminal via a voltage source.

In a preferred embodiment of the invention, the attenuator unit is a duplicated unit, made up of two metal-oxide-silicon field effect transistors (MOSFETS) connected in parallel between the terminals of the unit and the smoothing circuit via which said duplicated unit is connected firstly to the positive terminal of the battery and secondly to the corresponding positive terminal of the equipment. The grid control unit includes an RC circuit whose capacitive element is constituted by two capacitors in parallel between the terminal to which the output electrodes of the two transistors are connected, and a point common to the grids of said transistors, and also a resistive element made up of resistors distributed in two parallel branches, the two branches being connected firstly to the point common to the grids of the transistors, and secondly to the switch member which enables the assembly formed by said two branches to be connected in alternation either to the terminal to which the output terminals are connected, or else to said same terminal, via a voltage source.

### BRIEF DESCRIPTION OF THE DRAWING

The invention, its characteristics, and its advantages are described in greater detail in the following description given with reference to the sole figure as identified below.

The sole FIGURE is a theoretical circuit diagram of a device for smoothing current and voltage transients and for preventing an electric arc forming when a power supply battery and electrical equipment are connected together or disconnected.

### MORE DETAILED DESCRIPTION

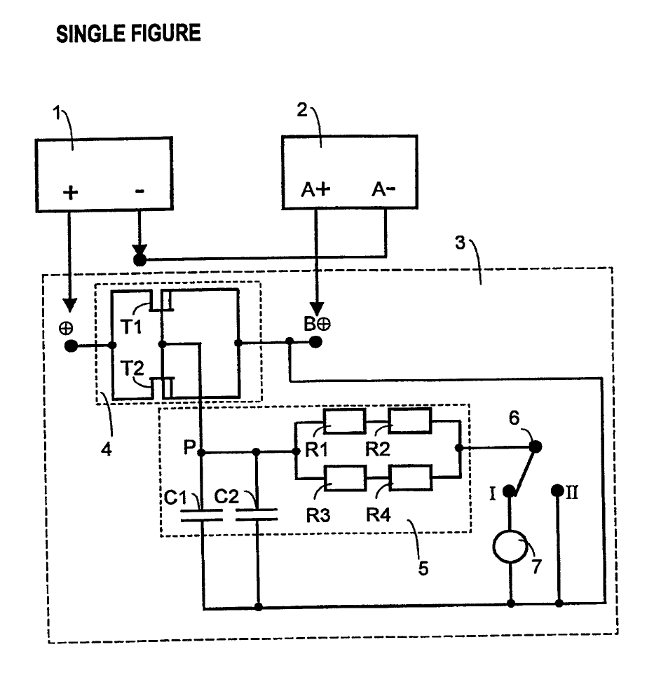

The device shown in FIG. 1 serves to smooth current and voltage transients and consequently to prevent an electric arc forming while making or breaking a connection between a power supply battery 1 (assumed to be of large capacity) and high power electrical equipment 2, e.g. a battery for powering equipment on board a satellite.

The device is intended more particularly for use in the context of operations where it is desired to eliminate any risk of an electric arc appearing when making or breaking a connection between a power supply battery and the electrical equipment it is to power and where said operations must be capable of being performed when the battery is fully charged.

The equipment 2 is powered by the battery 1 via two terminals, a positive terminal + and a negative terminal − on the battery, which terminals need to be connected for this purpose with two corresponding power supply terminals A+ and A− of the equipment. A first set of two terminals belonging one to the battery and the other to the equipment can be interconnected without risk, and in this case these terminals are taken to be the terminals and − A−.

Completing the circuit between the battery 1 and the equipment 2 then requires the battery terminal + to be connected to the power supply terminal A+ of the equipment. In the invention, this is achieved by using a circuit 3 for smoothing current and/or voltage transients, which circuit is inserted between the terminal + and the terminal A+. It is possible, and in this case recommended, to connect the smoothing circuit 3 to one of the terminals + and A+ before it is connected to the other, e.g. by connecting a terminal B⊕ of the circuit to the terminal A+ of the equipment, so that the operations of making and breaking the connection are performed between the battery terminal + and a terminal ⊕ of the smoothing circuit.

As is known, these operations of making and breaking a connection can be performed by means of complementary connector pieces respectively connected to the battery terminal + and to the terminal ⊕ of the smoothing circuit 3. These pieces are designed to be capable of being put either electrically into contact with each other, or else to be separated from each other so as to be no longer electrically connected together. This is not described in greater detail herein, insofar as mechanical means suitable for performing connection and disconnection operations are not the subject of the present invention.

The circuit 3 for smoothing current/voltage transients is designed to compensate any voltage unbalance that might exist between the battery terminal + and the terminal ⊕ of the smoothing circuit under conditions specified below at the instants of connection or of disconnection, whereby said terminals are either connected together or else are electrically separated from each other.

In one embodiment of the smoothing circuit 3 of the invention, this circuit comprises an attenuator unit 4 for interposing between the positive terminal + of the battery and the corresponding terminal A+ of the equipment, said smoothing circuit being placed between the terminal ⊕ and B⊕ of the smoothing circuit.

The attenuator unit 4 comprises at least one transistor, and in this case a pair of MOSFETs referenced T1 and T2 which are connected in parallel between the terminals ⊕ and B⊕ of the smoothing circuit. It acts on the current flowing between these terminals. To this end, a control unit 5 is provided for acting on the control electrode of each of the transistors, in this case its grid. The control unit 5 comprises an RC type circuit including a capacitive element which is duplicated for safety reasons and which is assumed in this case to comprise two capacitors C1 and C2 connected in parallel. The RC circuit also has a resistive element which in this case is constituted by two parallel branches each comprising two resistor R1 and R2 in one branch or R3 and R4 in the other branch. The unit constituting this resistive element is likewise duplicated for safety reasons, as is the unit 4.

The capacitors C1 and C2 are connected between a point P common to the grids of the transistors of the attenuator unit 4 and the terminal B⊕ to which the “output” electrodes of the two transistors T1 and T2 of said unit are connected, which electrodes are to be connected to the positive terminal of the battery. The two parallel branches constituted by the resistors are connected between the point P and a common terminal of a two-position switch member 6. This switch member makes it possible to connect both of these branches simultaneously either to the terminal B⊕, or else to a second terminal of a voltage source, itself connected via a first terminal to the terminal B⊕.

Establishing a connection between the equipment and the battery requires a series of connections to be made in succession. A connection must be established between the first terminal of the battery, e.g. the terminal − of said battery and the corresponding power supply terminal of the equipment, in this case the terminal A−. Another connection must likewise be made between a first terminal ⊕ or B⊕ of the attenuator unit and a second terminal which is either the second power supply terminal A+ of the equipment or else the second terminal of the battery, in this case assumed to be the terminal +. The connection that is then to be made is the connection which is critical since it leads to the equipment being powered and it is on this occasion that an arc might appear between the connector pieces involved in this operation. This third stage of establishing a connection is performed in this case between a second terminal of the attenuator unit, i.e. that one of its terminals ⊕ and B⊕ that still needs to be connected, and the battery terminal + or the equipment battery A+ that likewise remains to be connected.

In the invention, it is necessary for the switch member 6 to be positioned in such a manner that the voltage source 7 is in circuit with the resistive element of the control unit 5 so that the resistance presented by the attenuator unit is at its maximum, prior to establishing the connection between the battery and the equipment by performing the third step of establishing the connection. The positioning of the switch member 6 then directly connects the resistive elements to the terminal B⊕, as shown for position II in the FIGURE. The maximum value of the resistance is then reduced, after connection has been established, by placing the switch member 6 in such a manner that it connects the resistive element to the voltage source 7, as shown by position I.

When breaking a connection, the operations are performed in the reverse order so that the resistance presented by the attenuator unit is at a minimum when the connection between the smoothing circuit and either the battery or the equipment is itself interrupted. This interruption is assumed to be performed in this case by means of additional connector pieces (not shown) making it possible to unite either the battery terminal + to the terminal ⊕ of the smoothing circuit, or else the power supply terminal A+ of the equipment to the terminal B⊕ of the smoothing circuit.

Because of the duplication implemented in the smoothing circuit of the device of the invention, it is possible to ensure operation that is very safe, in particular if the switching member is made in such a manner as to be suitable for automatic control. The modular structure of the smoothing circuit enables it to be provided in such a manner as to take account of the power to be consumed.

In an embodiment of the invention, after the battery has been connected to the equipment, provision is made to connect the terminal ⊕ now connected to the battery, and the terminal B⊕ now connected to the equipment, directly to each other by means of an electric wire (not shown) taking the place of the smoothing circuit which can optionally be removed, in particular if no provision is made for the connection to be broken. The operation of establishing a connection via a wire that is then performed is not likely to lead to a spark being produced since the series resistance that then exists between the battery and the equipment is the resistance presented by the MOSFETs, and this resistance depends on the transistors that have been selected for this purpose and can thus be maintained at a value that is very small.

1/ A device for smoothing current and voltage transients and for preventing an electric arc being formed during a connection operation whereby a power supply battery is put into circuit with high-power electrical equipment that it is to power, and/or during the opposite, disconnection operation during which the circuit via which the battery powers the equipment is interrupted, the device providing for inserting a circuit for smoothing current/voltage transients to compensate for any voltage unbalance that might appear between the two terminals between which the connection between the battery and the equipment is alternately made and broken, one of the terminals belonging to the battery and the other to the equipment.

2/ A device according to claim 1, in which the transient smoothing circuit comprises:
an attenuator unit comprising at least one transistor for interposing between the positive terminal of the battery and the corresponding terminal of the equipment between which the connection between the battery and the equipment is alternately made and broken, the connection being obtained by successively interconnecting: a first terminal of the battery with a corresponding power supply terminal of the equipment; a first terminal of the attenuator unit and of the smoothing circuit with a second terminal which is either the second power supply terminal of the equipment or the second terminal of the battery; and then a second terminal of the attenuator unit and of the smoothing circuit with the battery terminal or the equipment terminal that remains to be connected; and
a control unit for controlling the grid of the transistor(s), said unit comprising an RC circuit including at least one capacitive element and at least one resistive element, the capacitive element being interposed between the control grid and the “output” electrode of at least one of said transistor(s), which is connected to the terminal of the device for connection to the positive terminal of the equipment, the resistive element being inserted between the control grid and a switch member which enables it to be connected in alternation either to the terminal of the device to which the output electrode(s) is/are connected, the resistive element then being connected in parallel with the capacitive element, or else to the same terminal via a voltage source.

3/ A device according to claim 2, in which the attenuator unit is a duplicated unit, made up of two MOSFETs connected in parallel between the terminals of the unit and the smoothing circuit via which said duplicated unit is connected firstly to the positive terminal of the battery and secondly to the corresponding positive terminal of the equipment, and in which the grid control unit includes an RC circuit whose capacitive element is constituted by two capacitors in parallel between the terminal to which the output electrodes of the two transistors are connected, and a point common to the grids of said transistors, and also a resistive element made up of resistors distributed in two parallel branches, the two branches being connected firstly to the point common to the grids of the transistors, and secondly to the switch member which enables the assembly formed by said two branches to be connected in alternation either to the terminal to which the output terminals are connected, or else to said same terminal, via a voltage source.
